(19) United States
(12) Patent Application Publication
(10) Pub. No.: US 2016/0085269 A1
(43) Pub. Date: Mar. 24, 2016

(54) TOUCH PANEL WITH MULTIPLE TOUCH-SENSITIVE SURFACES AND FLEXIBLE TOUCH SCREEN

(71) Applicant: JTOUCH Corporation, Jhongli City (TW)

(72) Inventors: Yu-Chou Yeh, Jhongli City (TW); Ting-Ching Lin, Jhongli City (TW); Yung-Chuan Hsu, Jhongli City (TW); Jia-Hao Kang, Jhongli City (TW)

(21) Appl. No.: 14/537,560

(22) Filed: Nov. 10, 2014

(30) Foreign Application Priority Data
Sep. 24, 2014 (TW) 103216968

(51) Int. Cl. G06F 1/16; G06F 3/041

(52) U.S. Cl. CPC G06F 1/1652; G06F 3/0412; G06F 1/1643; G06F 2203/04102

(57) ABSTRACT

A touch panel includes a flexible transparent substrate, a metal electrode and plural metal traces. The flexible transparent substrate includes a main segment, a first lateral segment, a second lateral segment, a first bent part and a second bent part. The metal electrode is disposed on a first surface of the flexible transparent substrate and distributed on the main segment, the first bent part and the second bent part, wherein a transparent touch zone is defined by the metal electrode. The plural metal traces are disposed over the flexible transparent substrate and distributed on a peripheral region of the transparent touch zone. The plural metal traces are extended to the main segment, the first bent part, the second bent part, the first lateral segment and the second lateral segment so as to be electrically connected with the metal electrode.

### FIELD OF THE INVENTION

The present invention relates to a touch panel and a touch screen, and more particularly to a touch panel with multiple touch-sensitive surfaces and a flexible touch screen.

### BACKGROUND OF THE INVENTION

Nowadays, touch control technologies are widely applied to the touch display devices of various electronic products in order to facilitate the users to control the operations of the electronic products. For example, the electronic products are mobile phones, tablet computers, portable computers or the like. These electronic products comprise casings and rigid touch screens. The rigid touch screen comprises a touch panel and a display panel. The touch panel and the display panel are collaboratively installed within the casing. Consequently, a displaying function and a touch control function are provided by a single surface of the casing.

Conventionally, a touch panel comprises a substrate, touch electrodes, plural contact pads and plural metal traces. The substrate is divided into a visible touch zone and a periphery wiring zone. The touch electrodes are disposed on the substrate and located at the visible touch zone. The plural contact pads and the plural metal traces are disposed on the substrate, and located at the periphery wiring zone. The plural metal traces are electrically connected with the corresponding touch electrodes and the corresponding contact pads. Since the plural contact pads and the plural metal traces occupy an area of a periphery surface of the substrate, it is difficult to implement a narrow-rim design or a rimless design on a single surface of the electronic product. Moreover, for allowing the plural contact pads and the plural metal traces of the periphery wiring zone to be invisible by the user, the periphery wiring zone is usually sheltered by a black frame. Consequently, the applications of the touch panel are limited, and the overall appearance of the electronic product is not aesthetically pleasing.

Moreover, for achieving the displaying function, transparent touch electrodes are used as the electrodes of the touch zone. For example, the transparent touch electrodes are made of indium tin oxide (ITO). However, the indium tin oxide material is too brittle and thick for bending or curving, which makes the electrical properties of the transparent touch electrodes are impaired or the transparent touch electrodes are possibly cracked or broken. Under this circumstance, the performance of the touch panel is deteriorated.

From the above discussions, the displaying function and the touch control function of the conventional touch screen can be provided by a single surface of the electronic product, and it is difficult to implement a narrow-rim design or a rimless design on a single surface of the electronic product. Moreover, if the substrate with the ITO electrodes is bent or curved, the electrical properties of the transparent touch electrodes are impaired.

Therefore, there is a need of providing an improved touch panel and an improved touch screen in order to overcome the above drawbacks.

### SUMMARY OF THE INVENTION

The present invention provides a touch panel with multiple touch-sensitive surfaces and a flexible touch screen. Consequently, the touch panel is bendable, and the rimless design and the multiple touch-sensitive surfaces are achievable.

The present invention further provides a touch panel with multiple touch-sensitive surfaces and a flexible touch screen. The touch panel can be produced by a one-bent or multi-bent forming process without using any other tools or auxiliary machining processes (e.g. punching or cutting). Consequently, the product reliability is enhanced.

In accordance with an aspect of the present invention, there is provided a touch panel with multiple touch-sensitive surfaces. The touch panel includes a flexible transparent substrate, a metal electrode and plural metal traces. The flexible transparent substrate includes a main segment, a first lateral segment, a second lateral segment, a first bent part and a second bent part. The first lateral segment and the second lateral segment are located at two opposite sides of the main segment. The first lateral segment is connected with the main segment through the first bent part. The second lateral segment is connected with the main segment through the second bent part. The metal electrode is disposed on a first surface of the flexible transparent substrate and distributed on the main segment, the first bent part and the second bent part, wherein a transparent touch zone is defined by the metal electrode. The plural metal traces are disposed on the first surface of the flexible transparent substrate and distributed on a peripheral region of the transparent touch zone. The plural metal traces are extended to the main segment, the first bent part, the second bent part, the first lateral segment and the second lateral segment, and the plural metal traces are electrically connected with the metal electrode.

In accordance with another aspect of the present invention, there is provided a flexible touch screen with multiple touch-sensitive surfaces. The flexible touch screen includes a touch panel and a flexible display panel. The touch panel includes a flexible transparent substrate, a metal electrode and plural metal traces. The flexible transparent substrate includes a main segment, a first lateral segment, a second lateral segment, a first bent part and a second bent part. The first lateral segment and the second lateral segment are located at two opposite sides of the main segment. The first lateral segment is connected with the main segment through the first bent part. The second lateral segment is connected with the main segment through the second bent part. The metal electrode is disposed on a first surface of the flexible transparent substrate and distributed on the main segment, the first bent part and the second bent part, wherein a transparent touch zone is defined by the metal electrode. The plural metal traces are disposed on the first surface of the flexible transparent substrate and distributed on a peripheral region of the transparent touch zone. The plural metal traces are extended to the main segment, the first bent part, the second bent part, the first lateral segment and the second lateral segment, and the plural metal traces are electrically connected with the metal electrode. The flexible display panel is attached on a second surface of the flexible transparent substrate of the touch panel. The flexible display panel includes at least one image display zone corresponding to the transparent touch zone of the touch panel.

The above contents of the present invention will become more readily apparent to those ordinarily skilled in the art after reviewing the following detailed description and accompanying drawings, in which:

### BRIEF DESCRIPTION OF THE DRAWINGS

FIG. 1A is a schematic perspective view illustrating the structure of a touch panel with multiple touch-sensitive surfaces according to a first embodiment of the present invention;

FIG. 1B is a schematic plane development view illustrating a metal electrode and plural metal traces on a flexible transparent substrate of the touch panel of FIG. 1A;

FIG. 1C is a schematic cross-sectional view illustrating a flexible touch screen with the touch panel of FIG. 1A;

FIG. 2A is a schematic perspective view illustrating the structure of a touch panel with multiple touch-sensitive surfaces according to a second embodiment of the present invention;

FIG. 2B is a schematic plane development view illustrating a metal electrode and plural metal traces on a flexible transparent substrate of the touch panel of FIG. 2A;

FIG. 2C is a schematic cross-sectional view illustrating a flexible touch screen with the touch panel of FIG. 2A;

FIG. 3A is a schematic perspective view illustrating the structure of a touch panel with multiple touch-sensitive surfaces according to a third embodiment of the present invention;

FIG. 3B is a schematic plane development view illustrating a metal electrode and plural metal traces on a flexible transparent substrate of the touch panel of FIG. 3A;

FIG. 3C is a schematic cross-sectional view illustrating a flexible touch screen with the touch panel of FIG. 3A;

FIG. 4A is a schematic perspective view illustrating the structure of a touch panel with multiple touch-sensitive surfaces according to a fourth embodiment of the present invention;

FIG. 4B is a schematic plane development view illustrating a metal electrode and plural metal traces on a flexible transparent substrate of the touch panel of FIG. 4A; and

FIG. 4C is a schematic cross-sectional view illustrating a flexible touch screen with the touch panel of FIG. 4A.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

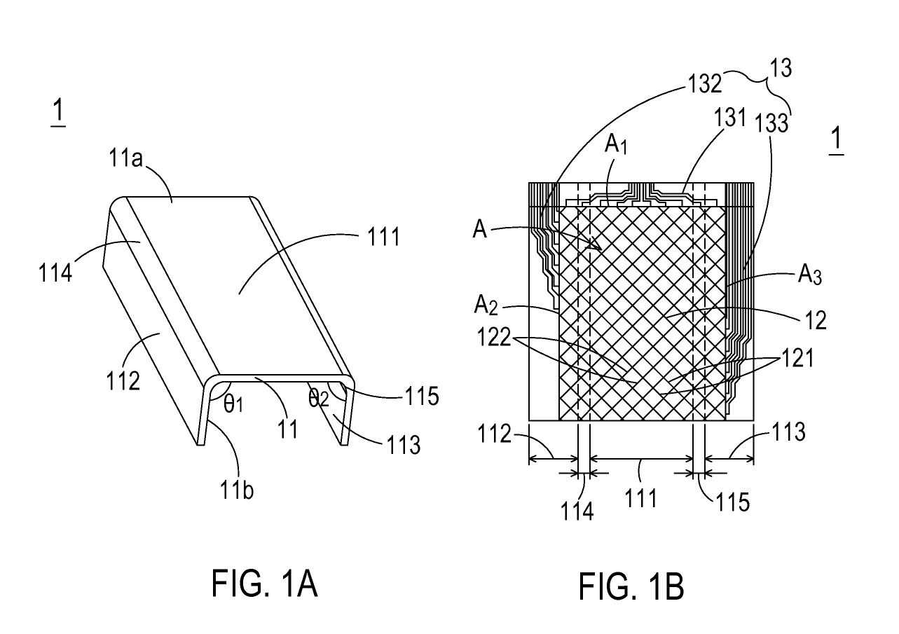

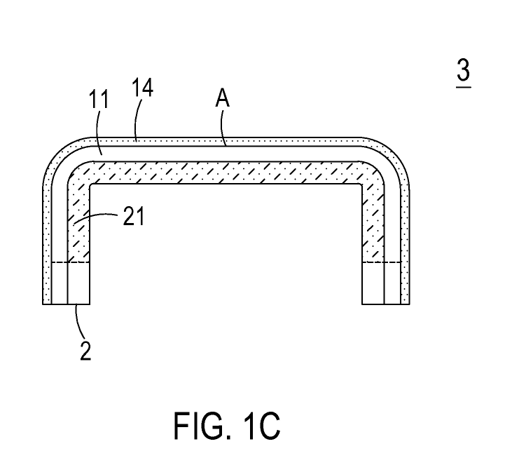

FIG. 1A is a schematic perspective view illustrating the structure of a touch panel with multiple touch-sensitive surfaces according to a first embodiment of the present invention. FIG. 1B is a schematic plane development view illustrating a metal electrode and plural metal traces on a flexible transparent substrate of the touch panel of FIG. 1A. FIG. 1C is a schematic cross-sectional view illustrating a flexible touch screen with the touch panel of FIG. 1A. The flexible touch screen 3 may be applied to an electronic product to provide a displaying function and a touch control function. An example of the electronic product includes but not limited to a mobile phone, a tablet computer, a portable computer, a wearable electronic device or a display device. In this embodiment, the flexible touch screen 3 comprises a touch panel 1 with multiple touch-sensitive surfaces and a flexible display panel 2. An example of the flexible display panel 2 includes but not limited to an organic light-emitting diode display panel or an electronic ink display panel. The touch panel 1 comprises a flexible transparent substrate 11, a metal electrode 12 and plural metal traces 13. The metal electrode 12 and the plural metal traces 13 are disposed on a first surface 11a of the flexible transparent substrate 11. The flexible transparent substrate 11 comprises a main segment 111, a first lateral segment 112, a second lateral segment 113, a first bent part 114 and a second bent part 115. The first lateral segment 112 and the second lateral segment 113 are located at two opposite sides of the main segment 111. In this embodiment, the first lateral segment 112 and the second lateral segment 113 are in parallel with each other. The first lateral segment 112 is connected with the main segment 111 through the first bent part 114. In particular, the main segment 111 is connected with a long side of the first bent part 114, and the first lateral segment 112 is connected with the other long side of the first bent part 114. The second lateral segment 113 is connected with the main segment 111 through the second bent part 115. In particular, the main segment 111 is connected with a long side of the second bent part 115, and the second lateral segment 113 is connected with the other long side of the second bent part 115.

Please refer to FIGS. 1A and 1B again. The metal electrode 12 is disposed on the first surface 11a of the flexible transparent substrate 11, and distributed on the main segment 111, the first bent part 114, the second bent part 115, at least a portion of the first lateral segment 112 and at least a portion of the second lateral segment 113. Consequently, a transparent touch zone A is defined by the metal electrode 12. In other words, the majority of the metal electrode 12 is disposed on the main segment 111 of the flexible transparent substrate 11. Moreover, the metal electrode 12 is extended to at least a portion of the first lateral segment 112 and at least a portion of the second lateral segment 113 through the first bent part 114 and the second bent part 115, so that the transparent touch zone A is defined by the metal electrode 12. In this embodiment, the metal electrode 12 comprises plural first metal lines 121 and plural second metal lines 122. The plural first metal lines 121 are oriented along a first direction and in parallel with each other. The plural second metal lines 122 are oriented along a second direction and in parallel with each other. The plural first metal lines 121 and the plural second metal lines 122 are separated and staggered with respect to each other. Consequently, a touch-sensitive array pattern is defined by the plural first metal lines 121 and the plural second metal lines 122 collaboratively. It is noted that the structure of the metal electrode 12 and the touch-sensitive array pattern are not restricted.

The plural metal traces 13 are disposed on the first surface 11a of the flexible transparent substrate 11. Moreover, the plural metal traces 13 are disposed over a periphery region of the transparent touch zone A, which is defined by the metal electrode 12. Moreover, the plural metal traces 13 are extended to the main segment 111, the first lateral segment 112, the second lateral segment 113, the first bent part 114 and the second bent part 115. Consequently, the plural metal traces 13 are connected with the metal lines of the metal electrode 12 corresponding to these segments and these bent parts. Under this circumstance, the metal electrode 12 may be electrically connected with an external circuit (not shown) through the plural metal traces 13, so that the touch control function of the touch panel 1 is achieved. In this embodiment, the plural metal traces 13 are divided into first-group metal traces 131, second-group metal traces 132 and third-group metal traces 133. The first-group metal traces 131 are distributed on a first part A1 of the periphery region of the transparent touch zone A. The second-group metal traces 132 are distributed on a second part A2 of the periphery region of the transparent touch zone A and extended toward the first-group metal traces 131. The third-group metal traces 133 are distributed on a third part A3 of the periphery region of the transparent touch zone A and extended toward the first-group metal traces 131. The second part A2 and the third part A3 are opposed to each other. The second part A2 and the third part A3 are connected with the first part A1. It is noted that the structures and wiring patterns of the plural metal traces 13 are not restricted.

The material of the flexible transparent substrate 11 may be selected from polyethylene terephthalate (PET), polyetherimide (PEI), polyphenylensulfone (PPSU), polyimide (PI), polyethylene naphthalate (PEN), cyclic olefin copolymer (COC), liquid crystal polymer (LCP) or a combination thereof. The material of the metal lines of the metal electrode 12 may be selected from copper, gold, silver, aluminum, tungsten, iron, nickel, chromium, titanium, molybdenum, indium, tin or a combination thereof.

Please refer to FIGS. 1A, 1B and 1C again. The flexible touch screen 3 comprises the touch panel 1 and the flexible display panel 2. The flexible display panel 2 is attached on a second surface 11b of the flexible transparent substrate 11. Moreover, the flexible display panel 2 comprises at least one image display zone 21 corresponding to the transparent touch zone A of the touch panel 1. Consequently, the flexible display panel 2 and the touch panel 1 are combined as the flexible touch screen 3 with multiple touch-sensitive surfaces. In some embodiments, the touch panel 1 further comprises a protective layer 14. The protective layer 14 is disposed over the flexible transparent substrate 11 to cover at least a portion of the metal electrode 12 and at least a portion of the metal traces 13 (not shown). By means of the protective layer 14, the metal electrode 12 and the metal traces 13 are not easily cracked, broken or short-circuited at the planar segments or the bent parts of the flexible transparent substrate 11. In this embodiment, the touch panel 1 has a specified thickness in the range between 20 μm and 75 μm. As shown in FIG. 1A, each of the first bent part 114 and the second bent part 115 has a bending angle (i.e. an R angle). Moreover, there is a first angle θ1 between the main segment 111 and the first lateral segment 112, and there is a second angle θ2 between the main segment 111 and the second lateral segment 113. These angles are smaller than 180 degrees, and preferably in the range between 0 and 90 degrees.

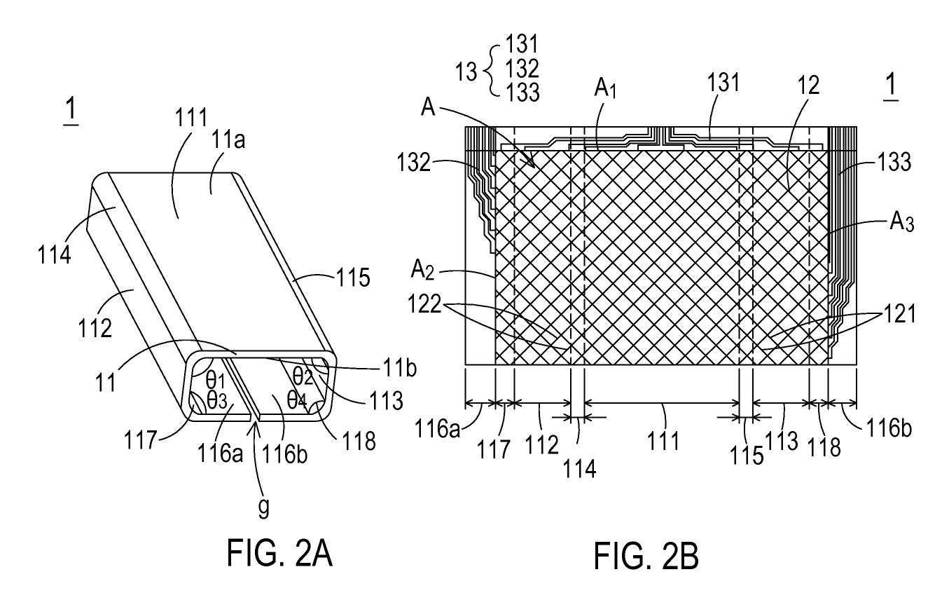

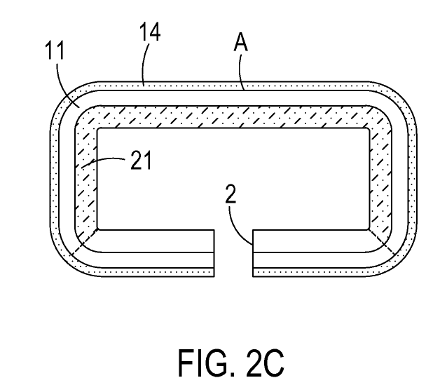

FIG. 2A is a schematic perspective view illustrating the structure of a touch panel with multiple touch-sensitive surfaces according to a second embodiment of the present invention. FIG. 2B is a schematic plane development view illustrating a metal electrode and plural metal traces on a flexible transparent substrate of the touch panel of FIG. 2A. FIG. 2C is a schematic cross-sectional view illustrating a flexible touch screen with the touch panel of FIG. 2A. Like the first embodiment, the touch panel 1 of this embodiment comprises a flexible transparent substrate 11, a metal electrode 12 and plural metal traces 13. The flexible transparent substrate 11 comprises a main segment 111, a first lateral segment 112, a second lateral segment 113, a first bent part 114 and a second bent part 115. Component parts and elements corresponding to those of the first embodiment are designated by identical numeral references, and detailed descriptions thereof are omitted. In this embodiment, the flexible transparent substrate 11 further comprises a first terminal segment 116a, a second terminal segment 116b, a third bent part 117 and a fourth bent part 118. The first terminal segment 116a is connected with the first lateral segment 112 through the third bent part 117. In particular, the first lateral segment 112 is connected with a long side of the third bent part 117, and the first terminal segment 116a is connected with the other long side of the third bent part 117. The second terminal segment 116b is connected with the second lateral segment 113 through the fourth bent part 118. In particular, the second lateral segment 113 is connected with a long side of the fourth bent part 118, and the second terminal segment 116b is connected with the other long side of the fourth bent part 118. Moreover, the first terminal segment 116a and the second terminal segment 116b are separated from each other by a gap g. Moreover, the first terminal segment 116a and the second terminal segment 116b are located at opposite sides of the main segment 111.

Please refer to FIGS. 2A and 2B again. The metal electrode 12 is disposed on the first surface 11a of the flexible transparent substrate 11. Moreover, the metal electrode 12 is distributed on the main segment 111, the first bent part 114, the second bent part 115, the first lateral segment 112, the second lateral segment 113, the third bent part 117 and the fourth bent part 118. Consequently, a transparent touch zone A is defined by the metal electrode 12. In this embodiment, the metal electrode 12 comprises plural first metal lines 121 and plural second metal lines 122. Consequently, a touch-sensitive array pattern is defined by the plural first metal lines 121 and the plural second metal lines 122 collaboratively. The structures of the plural first metal lines 121, the plural second metal lines 122 and the touch-sensitive array pattern are similar to those of the first embodiment, and are not redundantly described herein.

The plural metal traces 13 are disposed on the first surface 11a of the flexible transparent substrate 11. Moreover, the plural metal traces 13 are disposed over a periphery region of the transparent touch zone A, which is defined by the metal electrode 12. Like the first embodiment, the plural metal traces 13 are extended to the main segment 111, the first lateral segment 112, the second lateral segment 113, the first bent part 114 and the second bent part 115. Moreover, the plural metal traces 13 are further extended to the third bent part 117, the fourth bent part 118, the first terminal segment 116a and the second terminal segment 116b. Consequently, the plural metal traces 13 are connected with the metal lines of the metal electrode 12 corresponding to these segments and these bent parts. Under this circumstance, the metal electrode 12 may be electrically connected with an external circuit (not shown) through the plural metal traces 13, so that the touch control function of the touch panel 1 is achieved. In this embodiment, the plural metal traces 13 are divided into first-group metal traces 131, second-group metal traces 132 and third-group metal traces 133. The wiring positions of the three groups of metal traces are similar to those of the first embodiment, and are not redundantly described herein.

Please refer to FIGS. 2A, 2B and 2C again. The flexible touch screen 3 comprises the touch panel 1 and the flexible display panel 2. The flexible display panel 2 is attached on a second surface 11b of the flexible transparent substrate 11. Moreover, the flexible display panel 2 comprises at least one image display zone 21 corresponding to the transparent touch zone A of the touch panel 1. Consequently, the flexible display panel 2 and the touch panel 1 are combined as the flexible touch screen 3 with multiple touch-sensitive surfaces. In some embodiments, the touch panel 1 further comprises a protective layer 14. The protective layer 14 is disposed over the flexible transparent substrate 11 to cover at least a portion of the metal electrode 12 and at least a portion of the metal traces 13. The protective layer 14 prevents the metal electrode 12 and the metal traces 13 at the planar segments or the bent parts of the flexible transparent substrate 11 from being cracked, broken or short-circuited. In this embodiment, the touch panel 1 has a specified thickness in the range between 20 μm and 75 μm. As shown in FIG. 2A, each of the first bent part 114, the second bent part 115, the third bent part 117, the fourth bent part 118 has a bending angle (i.e. an R angle). Moreover, there is a first angle θ1 between the main segment 111 and the first lateral segment 112, there is a second angle θ2 between the main segment 111 and the second lateral segment 113, there is a third angle θ3 between the first lateral segment 112 and the first terminal segment 116a, and there is a fourth θ4 between the second lateral segment 113 and the second terminal segment 116b. These angles are smaller than 180 degrees, and preferably in the range between 0 and 90 degrees.

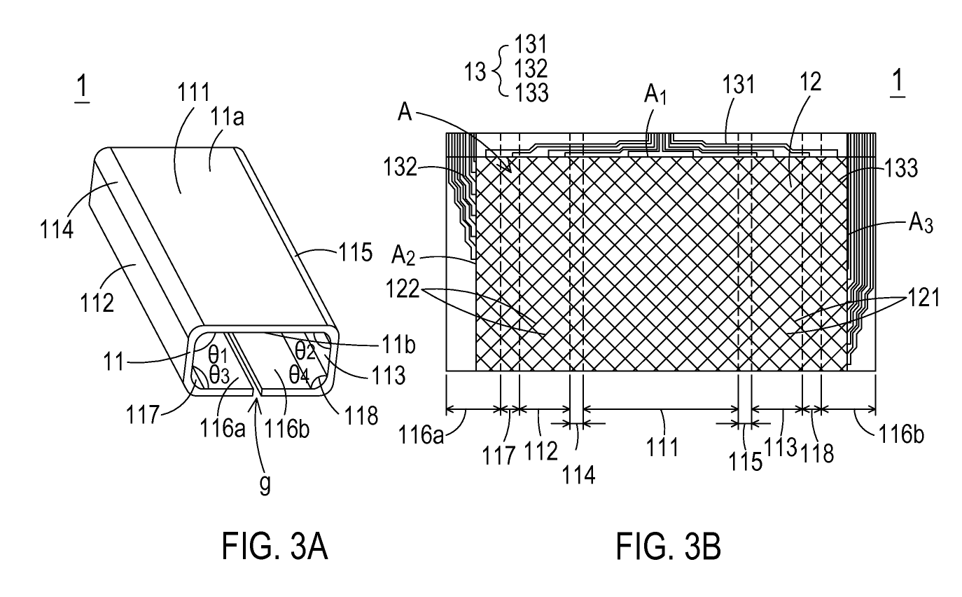

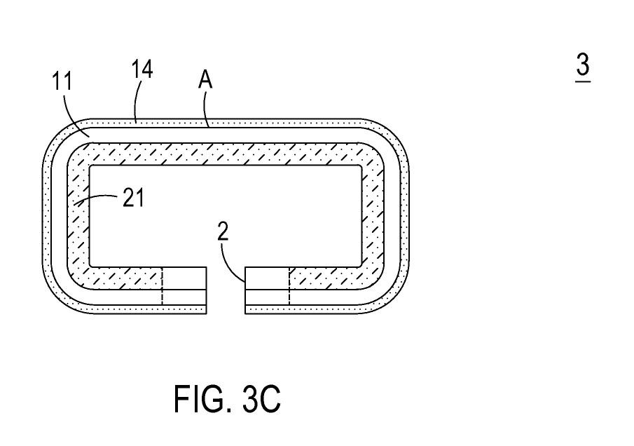

FIG. 3A is a schematic perspective view illustrating the structure of a touch panel with multiple touch-sensitive surfaces according to a third embodiment of the present invention. FIG. 3B is a schematic plane development view illustrating a metal electrode and plural metal traces on a flexible transparent substrate of the touch panel of FIG. 3A. FIG. 3C is a schematic cross-sectional view illustrating a flexible touch screen with the touch panel of FIG. 3A. Like the second embodiment, the touch panel 1 of this embodiment comprises a flexible transparent substrate 11, a metal electrode 12 and plural metal traces 13. Component parts and elements corresponding to those of the second embodiment are designated by identical numeral references, and detailed descriptions thereof are omitted. In comparison with the second embodiment, the metal electrode 12 is further extended to at least a portion of the first terminal segment 116a and at least a portion of the second terminal segment 116b. Consequently, a transparent touch zone A is defined by the metal electrode 12. Moreover, the plural metal traces 13 are disposed over a periphery region of the transparent touch zone A, which is defined by the metal electrode 12. The plural metal traces 13 are extended to the main segment 111, the first lateral segment 112, the second lateral segment 113, the first bent part 114, the second bent part 115, the third bent part 117, the fourth bent part 118, the first terminal segment 116a and the second terminal segment 116b. In this embodiment, the plural metal traces 13 are divided into first-group metal traces 131, second-group metal traces 132 and third-group metal traces 133. The wiring positions of the three groups of metal traces are similar to those of the second embodiment, and are not redundantly described herein.

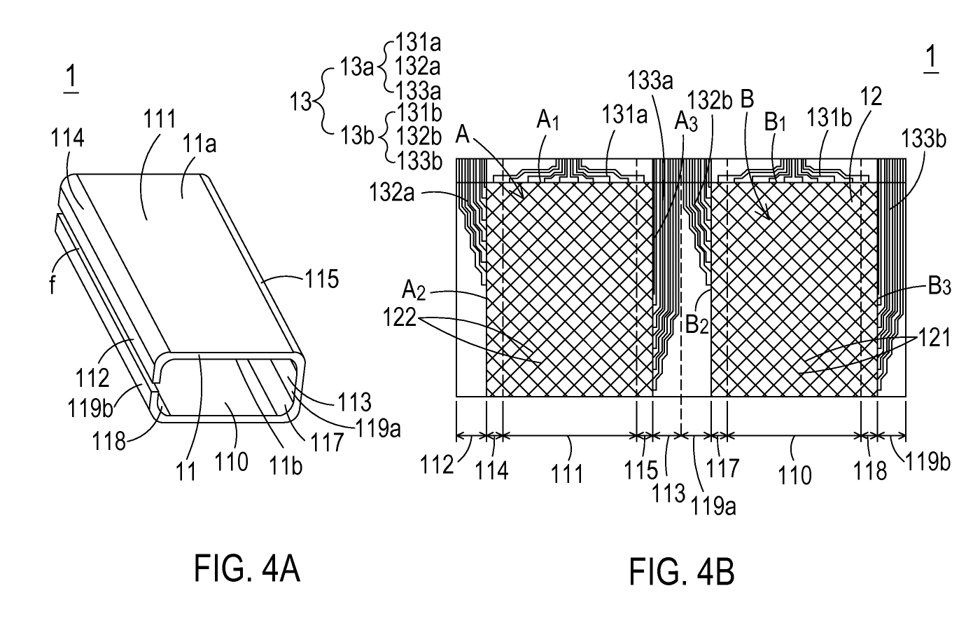

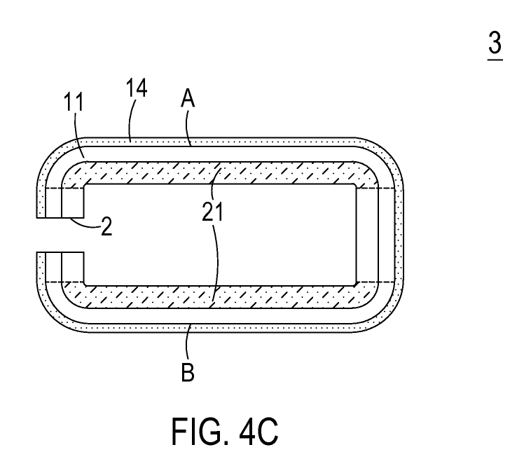

FIG. 4A is a schematic perspective view illustrating the structure of a touch panel with multiple touch-sensitive surfaces according to a fourth embodiment of the present invention. FIG. 4B is a schematic plane development view illustrating a metal electrode and plural metal traces on a flexible transparent substrate of the touch panel of FIG. 4A. FIG. 4C is a schematic cross-sectional view illustrating a flexible touch screen with the touch panel of FIG. 4A. In this embodiment, the touch panel 1 of this embodiment comprises a flexible transparent substrate 11, a metal electrode 12 and plural metal traces 13. The metal electrode 12 and the plural metal traces 13 are disposed on a first surface 11a of the flexible transparent substrate 11. The flexible transparent substrate 11 comprises a main segment 111, a first lateral segment 112, a second lateral segment 113, a first bent part 114, a second bent part 115, a minor segment 110, a third bent part 117, a fourth bent part 118, a third lateral segment 119a and a fourth lateral segment 119b. The first lateral segment 112 and the second lateral segment 113 are located at two opposite sides of the main segment 111. The first lateral segment 112 is connected with the main segment 111 through the first bent part 114. The second lateral segment 113 is connected with the main segment 111 through the second bent part 115. Moreover, the third lateral segment 119a and the fourth lateral segment 119b are located at two opposite sides of the minor segment 110. The third lateral segment 119a is connected with the minor segment 110 through the third bent part 117. The fourth lateral segment 119b is connected with the minor segment 110 through the fourth bent part 118. In this embodiment, the second lateral segment 113 and the third lateral segment 119a are directly connected with each other, and the second lateral segment 113 and the third lateral segment 119a are coplanar. The first lateral segment 112 and the fourth lateral segment 119b are separated from each other by a gap f.

Please refer to FIGS. 4A and 4B again. The metal electrode 12 is disposed on the first surface 11a of the flexible transparent substrate 11. The metal electrode 12 is distributed on the main segment 111, the first bent part 114 and the second bent part 115 so as to define a transparent touch zone A. Moreover, the metal electrode 12 is further distributed on the minor segment 110, the third bent part 117 and the fourth bent part 118 so as to define a minor transparent touch zone B. In this embodiment, the metal electrode 12 comprises plural first metal lines 121 and plural second metal lines 122. Consequently, a touch-sensitive array pattern is defined by the plural first metal lines 121 and the plural second metal lines 122 collaboratively. The structures of the plural first metal lines 121, the plural second metal lines 122 and the touch-sensitive array pattern are similar to those of the first embodiment, and are not redundantly described herein.

The plural metal traces 13 are disposed on the first surface 11a of the flexible transparent substrate 11. Moreover, the plural metal traces 13 are disposed over periphery regions of the transparent touch zone A and the minor transparent touch zone B, which are defined by the metal electrode 12. The plural metal traces 13 are distributed on the periphery region of the transparent touch zone A, and extended to the main segment 111, the first bent part 114, the second bent part 115, the first lateral segment 112 and the second lateral segment 113. Consequently, the plural metal traces 13 are connected with the metal lines of the metal electrode 12 corresponding to the transparent touch zone A. Moreover, the plural metal traces 13 are further extended to the minor segment 110, the third bent part 117, the fourth bent part 118, the third lateral segment 119a and the fourth lateral segment 119b. Consequently, the plural metal traces 13 are connected with the metal lines of the metal electrode 12 corresponding to the minor transparent touch zone B. Under this circumstance, the metal electrode 12 may be electrically connected with an external circuit (not shown) through the plural metal traces 13, so that the touch control function of the touch panel 1 is achieved.

In this embodiment, the plural metal traces 13 are divided into plural main metal traces 13a and plural minor metal traces 13B. The plural main metal traces 13a are divided into first-group main metal traces 131a, second-group main metal traces 132a and third-group main metal traces 133a. The plural minor metal traces 13b are divided into first-group minor metal traces 131b, second-group minor metal traces 132b and third-group minor metal traces 133b. The first-group main metal traces 131a of the plural main metal traces 13a are distributed on a first part A1 of the periphery region of the transparent touch zone A. The second-group main metal traces 132a of the plural main metal traces 13a are distributed on a second part A2 of the periphery region of the transparent touch zone A and extended toward the first-group main metal traces 131a. The third-group main metal traces 133a of the plural main metal traces 13a are distributed on a third part A3 of the periphery region of the transparent touch zone A and extended toward the first-group main metal traces 131a. The second part A2 and the third part A3 are opposed to each other. The second part A2 and the third part A3 are connected with the first part A1. The first-group minor metal traces 131b of the plural minor metal traces 13b are distributed on a first part B1 of the periphery region of the minor transparent touch zone B. The first-group minor metal traces 132b of the plural minor metal traces 13b are distributed on a second part B2 of the periphery region of the minor transparent touch zone B and extended toward the first-group minor metal traces 131b. The third-group minor metal traces 133b of the plural minor metal traces 13b are distributed on a third part B3 of the periphery region of the minor transparent touch zone B and extended toward the first-group minor metal traces 131b. The second part B2 and the third part B3 are opposed to each other. The second part B2 and the third part B3 are connected with the first part B1. It is noted that the structures and wiring patterns of the plural metal traces 13 are not restricted.

Please refer to FIGS. 4A, 4B and 4C again. The flexible touch screen 3 comprises the touch panel 1 and the flexible display panel 2. The flexible display panel 2 is attached on a second surface 11b of the flexible transparent substrate 11. Moreover, the flexible display panel 2 comprises at least one image display zone 21 corresponding to the transparent touch zone A and the minor transparent touch zone B of the touch panel 1. Consequently, the flexible display panel 2 and the touch panel 1 are combined as the flexible touch screen 3 with multiple touch-sensitive surfaces. In some embodiments, the touch panel 1 further comprises a protective layer 14. The protective layer 14 is disposed over the flexible transparent substrate 11 to cover at least a portion of the metal electrode 12 and at least a portion of the metal traces 13. By means of the protective layer 14, the metal electrode 12 and the metal traces 13 at the planar segments or the bent parts of the flexible transparent substrate 11 are not cracked, broken or short-circuited.

From the above descriptions, the present invention provides a touch panel with multiple touch-sensitive surfaces and a flexible touch screen. Consequently, the touch panel is bendable, and the rimless design and the multiple touch-sensitive surfaces are achievable. Moreover, the touch panel can be produced by a one-bent or multi-bent forming process without the need of using other tools or auxiliary machining processes (e.g. punching or cutting processes). Under this circumstance, since the water vapor instruction or the structural damage is avoided, the product reliability is enhanced.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A touch panel with multiple touch-sensitive surfaces, the touch panel comprising:
a flexible transparent substrate comprising a main segment, a first lateral segment, a second lateral segment, a first bent part and a second bent part, wherein the first lateral segment and the second lateral segment are located at two opposite sides of the main segment, wherein the first lateral segment is connected with the main segment through the first bent part, and the second lateral segment is connected with the main segment through the second bent part;
a metal electrode disposed on a first surface of the flexible transparent substrate and distributed on the main segment, the first bent part and the second bent part, wherein a transparent touch zone is defined by the metal electrode; and
plural metal traces disposed on the first surface of the flexible transparent substrate and distributed on a peripheral region of the transparent touch zone, wherein the plural metal traces are extended to the main segment, the first bent part, the second bent part, the first lateral segment and the second lateral segment, and the plural metal traces are electrically connected with the metal electrode.

2. The touch panel according to claim 1, wherein the metal electrode is further distributed on at least a portion of the first lateral segment and at least a portion of the second lateral segment, and the transparent touch zone is defined by the metal electrode.

3. The touch panel according to claim 1, wherein the flexible transparent substrate further comprises a first terminal segment, a second terminal segment, a third bent part and a fourth bent part, wherein the first terminal segment is connected with the first lateral segment through the third bent part, and the second terminal segment is connected with the second lateral segment through the fourth bent part, wherein the first terminal segment and the second terminal segment are separated from each other by a gap, and the first terminal segment and the second terminal segment are located at opposite sides of the main segment.

4. The touch panel according to claim 3, wherein the metal electrode is distributed on the main segment, the first bent part, the second bent part, the first lateral segment, the second lateral segment, the third bent part and the fourth bent part, and the transparent touch zone is defined by the metal electrode, wherein the plural metal traces are distributed on the peripheral region of the transparent touch zone, wherein the plural metal traces are extended to the main segment, the first bent part, the second bent part, the first lateral segment, the second lateral segment, the third bent part, the fourth bent part, the first terminal segment and the second terminal segment, and the plural metal traces are electrically connected with the metal electrode.

5. The touch panel according to claim 4, wherein the metal electrode is further distributed on at least a portion of the first terminal segment and at least a portion of the second terminal segment, and the transparent touch zone is defined by the metal electrode.

6. The touch panel according to claim 1, wherein the flexible transparent substrate further comprises a minor segment, a third bent part, a fourth bent part, a third lateral segment and a fourth lateral segment, wherein the third lateral segment is connected with the minor segment through the third bent part, the fourth lateral segment is connected with the minor segment through the fourth bent part, and the third lateral segment is connected with the second lateral segment.

7. The touch panel according to claim 6, wherein the metal electrode is distributed on the main segment, the first bent part and the second bent part so as to define the transparent touch zone, and the metal electrode is further distributed on the minor segment, the third bent part and the fourth bent part so as to define a minor transparent touch zone, wherein the plural metal traces are distributed on the peripheral region of the transparent touch zone and extended to the main segment, the first bent part, the second bent part, the first lateral segment and the second lateral segment so as to be electrically connected with the metal electrode corresponding to the transparent touch zone, wherein the plural metal traces are further extended to the minor segment, the third bent part, the fourth bent part, the third lateral segment and the fourth lateral segment so as to be electrically connected with the metal electrode corresponding to the minor transparent touch zone.

8. The touch panel according to claim 1, further comprising a protective layer, wherein the protective layer is disposed on the first surface of the flexible transparent substrate to cover at least a portion of the metal electrode and at least a portion of the metal traces.

9. The touch panel according to claim 1, wherein the touch panel has a specified thickness in a range between 20 μm and 75 μm.

10. A flexible touch screen with multiple touch-sensitive surfaces, the flexible touch screen comprising:
a touch panel comprising:
a flexible transparent substrate comprising a main segment, a first lateral segment, a second lateral segment, a first bent part and a second bent part, wherein the first lateral segment and the second lateral segment are located at two opposite sides of the main segment, wherein the first lateral segment is connected with the main segment through the first bent part, and the second lateral segment is connected with the main segment through the second bent part;
a metal electrode disposed on a first surface of the flexible transparent substrate and distributed on the main segment, the first bent part and the second bent part, wherein a transparent touch zone is defined by the metal electrode; and
plural metal traces disposed on the first surface of the flexible transparent substrate and distributed on a peripheral region of the transparent touch zone, wherein the plural metal traces are extended to the main segment, the first bent part, the second bent part, the first lateral segment and the second lateral segment, and the plural metal traces are electrically connected with the metal electrode; and
a flexible display panel attached on a second surface of the flexible transparent substrate of the touch panel, wherein the flexible display panel comprises at least one image display zone corresponding to the transparent touch zone of the touch panel.
